(19) United States
(12) Patent Application Publication
(10) Pub. No.: US 2015/0041043 A1
(43) Pub. Date: Feb. 12, 2015

(54) DEVICE AND METHOD FOR LABELING

(71) Applicant: Multivac Marking & Inspection GmbH & Co. KG, Enger (DE)

(72) Inventors: Georg Austermeier, Hovelhof (DE); Karsten Strothmann, Versmold (DE)

(21) Appl. No.: 14/451,049

(22) Filed: Aug. 4, 2014

(30) Foreign Application Priority Data
Aug. 6, 2013 (DE) 102013013077.8

(51) Int. Cl. B65C 9/08; B65C 1/02; B65C 9/00; B65C 9/26

(52) U.S. Cl. CPC B65C 9/08; B65C 9/26; B65C 1/02; B65C 9/00
USPC 156/60; 156/539; 156/535

(57) ABSTRACT

The invention relates to a device for labeling packages in a thermo-forming packaging machine with a first depositor device and a second depositor device, where a dispensing unit simultaneously transfers the labels from a label roll onto the first and second depositor devices. The invention also relates to a method for labeling packages in a thermo-forming packaging machine.

### CROSS-REFERENCE TO RELATED APPLICATIONS

This Application claims priority to German Patent Application Number 102013013077.8 filed Aug. 6, 2013, to Georg Austermeier and Karsten Strothmann entitled “Device and Method for Labeling,” currently pending, the entire disclosure of which is incorporated herein by reference.

### FIELD OF THE INVENTION

The present invention relates to a device for labeling and to a method for labeling packages in a thermo-forming packaging machine.

### BACKGROUND OF THE INVENTION

Cross-web labeler with a dispensing unit and a depositor box are known from DE 10 2008 007 890 A1 and DE 102 28 243 A1. The dispensing unit dispenses a row of labels onto the depositor box and the cross-web labeler is moved to the transfer position to apply the row of labels onto a row of packages. The cycle period for dispensing and applying a label row is too long to be able to label a multi-lane and multi-row format or group of packages in a high-performance and intermittently operating thermo-forming packaging machine. In such a case, two of the above-mentioned cross-web labelers are used which each label half of the packages at the same time. Firstly, this is cost-intensive and, secondly, an increased effort is necessary to be able to operate two adjacent and simultaneously moving cross-web labelers in terms of safety measures, namely, observing prescribed safety distances. A labeler is also known from DE 197 37 458 A1 that can label unprocessed packaging film in two rows, but no finished packages.

### SUMMARY OF THE INVENTION

The object of the present invention is to provide a labeling device that can be designed more cost-effectively or in a structurally simpler manner than known in prior art for labeling packages in a high-performance thermo-forming packaging machine.

The device according to one embodiment of the present invention for labeling a plurality of rows and/or lanes of packages uses a first and a second depositor device and one dispensing unit for both depositor devices configured to simultaneously dispense a first row of labels to the first depositor device and a second row of labels to the second depositor device. This entails the advantage that approximately the same performance (number of labels per unit time) can be obtained with just one dispensing unit and two depositor devices as with two cross-web labelers each comprising one dispensing unit and one depositor device. This results in high savings of costs and the space required for labeling in a thermo-forming packaging machine is reduced. Compared to only one cross-web labeler, the device can, due to a double-row label roll, dispense twice the number of labels until a label roll needs to be replaced. This reduces the down time, for example, of a thermo-forming packaging machine in which the device is provided.

According to one embodiment of the present invention, a common drive is provided for the dispensing unit and the depositor devices. In this, the dispensing unit and the depositor devices can be combined in a manner to form a module, i.e., coupled to each other, such that they are jointly adjustable in their position by the common drive. This is preferably a linear adjustment, namely parallel to a direction of transport of the packages to be labeled. This enables easy position adjustment of the depositor devices in a constructively simple manner to the positions of the packages for being able to apply the labels as precisely as possible onto predetermined locations on the packages.

The direction of movement of the common drive can be performed, for example, using a servo motor, preferably in the horizontal direction and perpendicular to the dispensing direction of the dispensing unit. Labeling of rows as well as lanes of the packages is thereby enabled in a deep-drawing packaging machine.

The depositor devices can be separately actuated for applying the labels consecutively onto the packages. The first depositor device can therefore apply its labels to a first row of packages and the second depositor device can subsequently be moved to the position for applying its labels onto a second row of packages. This also allows for the lateral spacing of two rows of labels disposed in parallel on a common carrier strip on the dispensing unit to differ from the spacing of adjacent packages in the thermo-forming packaging machine and the labels can each always have the same position on the packages. The depositor devices can be actuated with at least one drive, for example a pneumatic cylinder.

The dispensing unit may be configured to receive a label roll and to process a carrier strip with two label rows, because set-up time is saved with a change of only one label roll with two parallel label rows as compared to a change of two label rows each with one label row.

The device for labeling comprises a particularly advantageous embodiment of a thermo-forming packaging machine.

The direction of movement of the common drive is preferably provided in and against a direction of processing of the thermo-forming packaging machine for labeling rows of packages. Alternatively, the direction of movement of the common drive can be provided transversely to the direction of processing of the thermo-forming packaging machine for labeling lanes of packages.

The method according to one embodiment of the present invention for labeling packages in a thermo-forming packaging machine using a device comprising a dispensing unit and one first and one second depositor device, provides the steps of:

simultaneously dispensing two rows of labels being parallel to each other from the dispensing unit to each one depositor device,

applying a first row of labels from the first depositor device onto a first row of packages,

applying a second row of labels from the second depositor device onto a second row of packages,

joint positioning of the dispensing unit and the depositor devices to a next (i.e., different) position,

repeatedly dispensing two label rows being parallel to each other from the dispensing unit onto the depositor devices,

applying a third row of labels from the first depositor device onto a third row of packages, and

applying a fourth row of labels from the second depositor device onto a fourth row of packages.

Compared with two cross-web labelers disposed parallel to each other according to prior art, the space requirements can be greatly reduced since no safety distances must be observed between two parallel and simultaneously operating cross-web labelers.

Application of the labels using the first and the second depositor device can preferably be performed simultaneously if their spacing or the spacing of the label rows to each other prior to application corresponds to the spacing on the packages or the package rows or package lanes, respectively, in order to reduce the labeling time or to increase labeling performance.

Between application of the labels on the first and the third row of packages, respectively, and application of the labels on the second and the fourth row of packages, respectively, the dispensing unit and the two depositor devices can alternatively be jointly moved to a position provided for the second or the fourth row, respectively, in order to apply the labels in the intended position on the packages.

The labels can be transferred off a two-lane label roll from the dispensing unit onto the first and the second depositor device.

It is also conceivable that the depositor devices are adjustable relative to each other in order to adjust the distance of these label rows, which corresponds to the spacing on the carrier strip on the dispensing unit, after the labels have been dispensed onto the depositor devices, such that the spacing of the label rows after the adjustment corresponds to the spacing of the packages or the position of the labels on the packages, respectively, and both depositor devices therefore can apply their labels simultaneously onto two rows or two lanes of packages.

Other and further objects of the invention, together with the features of novelty appurtenant thereto, will appear in the course of the following description.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a schematic side view of a thermo-forming packaging machine with a device for labeling according to one embodiment of the present invention;

FIG. 2 is a side view of a device for labeling according to one embodiment of the present invention;

FIG. 3 is a perspective view of the device for labeling of FIG. 2 after the labels have been dispensed;

FIG. 4 is a perspective view of the device for labeling of FIG. 2 with an actuated first depositor device;

FIG. 5 is a perspective view of the device for labeling of FIG. 2 with an actuated second depositor device; and

FIG. 6 is a perspective view of the device for labeling of FIG. 2 in a next position with further labels dispensed.

Same components are throughout the figures designated with the same reference numerals.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

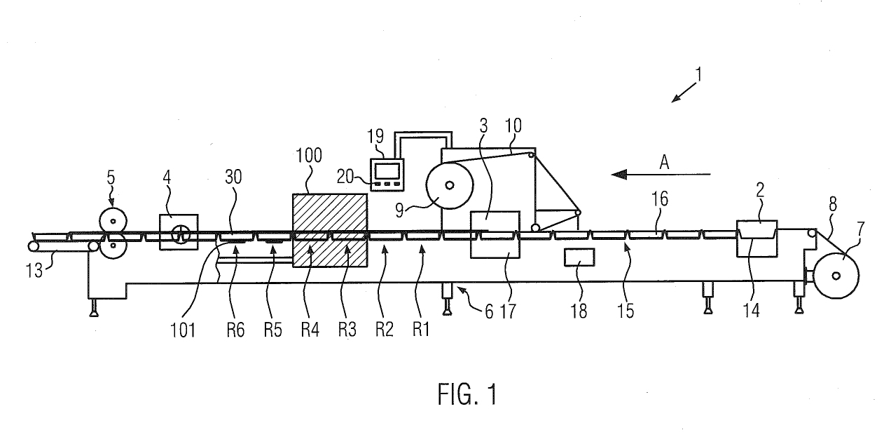

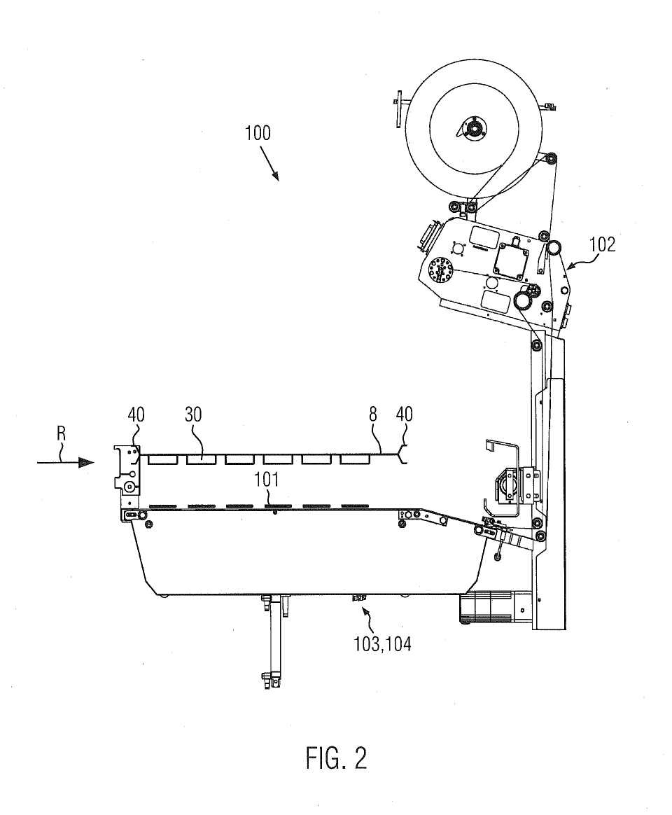

FIG. 1 shows a schematic view of a packaging machine 1 according to one embodiment of the present the invention in the form of a thermo-forming packaging machine. This thermo-forming packaging machine 1 may comprise a forming station 2, a sealing station 3, a device 100 for labeling, a transverse cutting device 4 and a longitudinal cutting device 5, which are arranged in this sequence in a direction of processing A on a machine frame 6. On the inlet side, the machine frame 6 has a supply roll 7 disposed on it from which a film 8 is drawn off. In the region of the sealing station 3, a material storage 9 can be provided from which a top film 10 is drawn off The packaging machine 1 may comprise a discharge device 13 on the outlet side in the form of a transport belt 13 with which the fully separated packages are removed. Furthermore, the packaging machine 1 can comprise an advance device—not illustrated—which grips the film 8 in order to further transport it with every main processing cycle in the direction of processing A. The advance device can be embodied, for example, by conveyor chains disposed on both sides, also known as clamp chains 40 (see FIG. 2).

In the embodiment illustrated, the forming station 2 is formed as a thermo-forming station in which trays 14 are formed into the film 8 by thermo-forming. In this, the forming station 2 can be designed such that several trays can be formed next to one another in the direction perpendicular to the direction of processing A. In the direction of processing A downstream of the forming station 2, a loading stretch 15 is provided in which the trays 14 formed into the film 8 are filled with product 16.

The sealing station 3 may have a sealable chamber 17 in which the atmosphere in the trays 14 can, e.g., by flushing with a gas prior to sealing, be replaced with an exchange gas or a gas mixture.

The device 100 for labeling the packages 30 that have been produced with film 8 after sealing the top film 10 can be disposed downstream of the sealing station for providing all packages 30 with a label. In this embodiment, a label 101 is applied to the underside of each tray 14. The mode of operation of the device 100 shall be described in more detail in the further FIGS. 2 through 7.

The transverse cutting device 4 may be designed as a punch that severs the film 8 and the top film 10 between adjacent trays 14 in a direction transverse to the direction of processing A. The transverse cutting device 4 here operates in such a manner that the film 8 is not severed across the entire width, but is not severed at least in one edge region. This enables controlled further transport by the advance device.

The longitudinal cutting device 5 is in the illustrated embodiment configured as a blade assembly with which the film 8 and the top film 10 are cut between adjacent trays 14 and at the side edge of the film 8, so that separated packages 30 are given downstream of the longitudinal cutting device 5.

The thermo-forming packaging machine 1 may also comprise a control unit 18. It serves the purpose of controlling and monitoring the processes running in the thermo-forming packaging machine 1. A display device 19 with control elements 20 may be used for visualizing or influencing the processes in the packaging machine 1 for or by an operator, respectively.

The general mode of operation of one embodiment of the packaging machine 1 is described briefly herebelow.

The film 8 is drawn off from the feed roller 7 and transported by the advance device into the forming station 2. In the forming station 2, the trays 14 are formed into the film 8 by thermo-forming. The trays 14 are together with the surrounding area of the film 8 further transported in a main processing cycle to the loading stretch 15 in which they are filled with product 16.

The filled trays 14 together with the surrounding area of the film 8 are then in the main processing cycle transported by the advance device into the sealing station 3. Following a sealing process onto the film 8, the top film 10 is further transported with the advance motion of the film 8. In this, the top film 10 is drawn off from the material storage 9. By sealing the top film 10 onto the trays 14, sealed packages 30 are created that are subsequently provided with labels by a device 100 before they are separated in the subsequent cuts 4 and 5 and with the discharge device 13 removed from the thermo-forming packaging machine

FIG. 2 shows the device 100 for labeling packages 30 that are transported intermittently in the direction of processing A still as a compound structure via the film 8 using two clamping chains 40 disposed on both sides. The view shows the device 100 opposite to the direction of operation A and shows a row R with six packages 30. The thermo-forming packaging machine in this example therefore comprises six lanes of packages in the direction of operation. As shown in FIG. 1, six rows R for six lanes S, i.e., thirty-six packages 30, are to be labeled by the device 100 in one working cycle while the film advance is halted. The device 100 may comprise one dispensing unit 102 and a first depositor device 103 which is—not visible in the drawing—disposed directly behind a second depositor device 104.

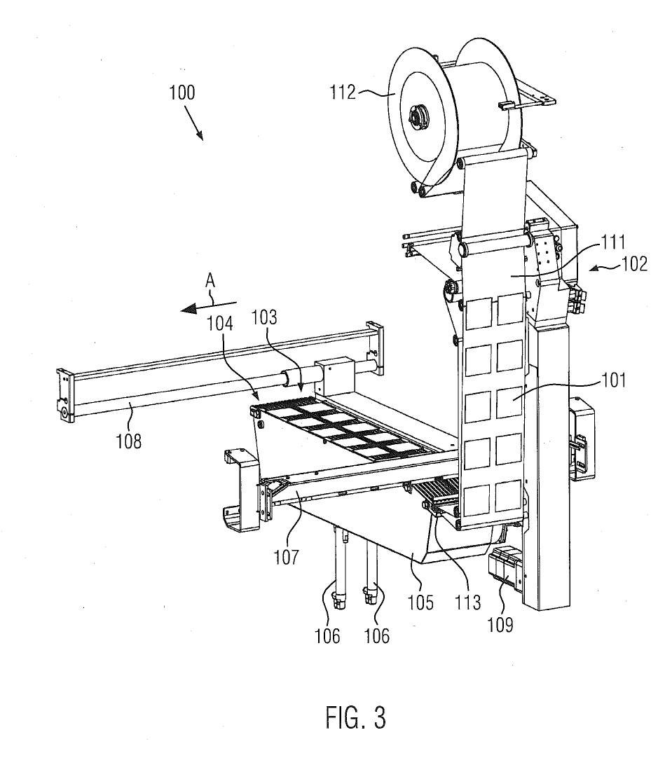

FIG. 3 shows the device 100 in an angular view. The first 103 and second depositor device 104 can be integrated into a common depositor box 105 and each have their dedicated drive 106. The dispensing unit 102 may be mechanically connected to the depositor box 105 and thereby also to the first 103 and second depositor device 104 to form a module, and is movable via two guides 107 and 108 linearly in and against the direction of operation A using a servo motor 109 and a toothed belt drive—not shown in detail. The servo motor 109 in this embodiment therefore forms the common drive for moving the dispensing unit 102 connected to the depositor devices 103, 104 to form a module.

As shown, the labels 101 located on a carrier strip 111 are wound off by the dispensing unit 102 from a label roll 112, transported in the direction of the depositor devices 103, 104, and at a dispensing edge 113 of the dispensing unit 102 removed from the carrier strip 111 and dispensed or transferred from the dispensing unit 102 to the depositor devices 103, 104.

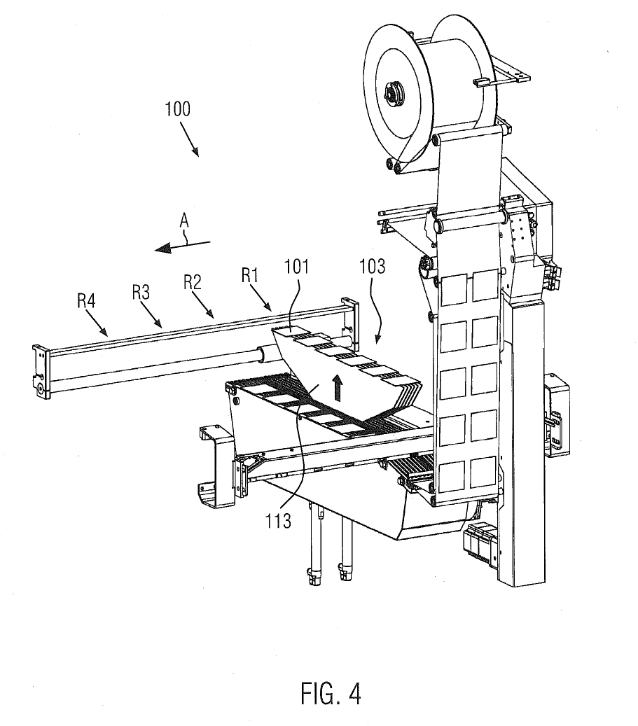

FIG. 4 shows the device 100 in a position in which the first depositor device 103 has with a set of pusher plates 113 raised the six labels 101 dispensed in one row in the direction of the packages 30 no longer shown in FIG. 4 in order to apply the labels 101 onto a first row R1 (see also FIG. 1) of packages 30.

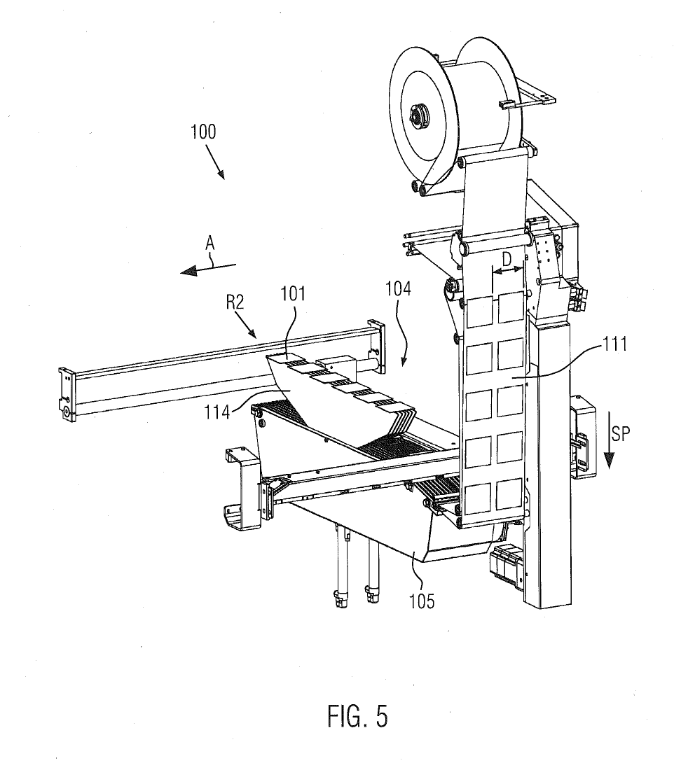

FIG. 5 shows the device 100 in a position in which the first depositor device 103 was again moved back downwardly to its normal position and subsequently or in a time-overlap the second depositor device 104 has, using a set of pusher plates 114, raised its six labels 101 dispensed in one row in the direction of the packages 30 no longer shown in FIG. 4 in order to apply the labels 30 onto a second row R2 (see also FIG. 1) of packages 30. Prior to or during the raising of the labels 101 by the set of pusher plates 114, the dispensing unit 102 can with the depositor box 105 be moved in or against the direction of operation A to move the labels 101 of the second depositor device 104 in the intended position. This is advantageous if the distance D of two labels 101 that are adjacent on the carrier strip 111 in the direction of dispensing SP does not correspond to the distance between two adjacent rows R, for example R1 and R2, of the packages 30.

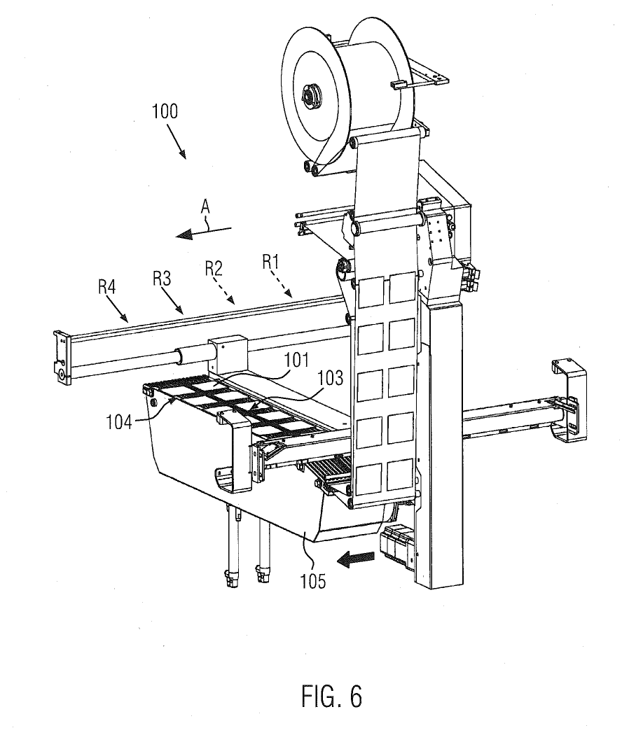

FIG. 6 shows the device 100 in a position in which the dispensing unit 102 is moved with the depositor box 105 in the direction of operation A, in order to apply labels 101 in this position with the first depositor device 103 onto a third row R3 of packages 30. A fourth row R4 can in analogy to the first and second rows R1, R2 occur simultaneous or subsequently by the second depositor device 104.

The invention also relates to a device with which rows R of packages 30 can in the opposite direction to the direction of operation A of the thermo-forming packaging machine 1 consecutively be provided with labels 101, namely, rows R1 and R2, at the end of a working cycle. The device preferably after each working cycle changes direction in which the rows of packages are consecutively provided with labels 101.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. Device for labeling a plurality of rows and/or lanes of packages, said device comprising:
a first depositor device;
a second depositor device; and
a dispensing unit that is common for said first and second depositor devices and is designed to simultaneously dispense a first row of labels onto said first depositor device and a second row of labels onto said second depositor device;
where said dispensing unit and said first and second depositor devices are combined to form a module such that they are jointly adjustable in their position by a common drive.

2. Device according to claim 1, wherein a direction of movement of said common drive can be performed in a horizontal direction and perpendicular to a dispensing direction of said dispensing unit.

3. Device according to claim 1, wherein said depositor devices can be actuated separately from each other for consecutively applying said labels onto said packages.

4. Device according to claim 3, wherein said the depositor devices can be actuated by at least one drive.

5. Device according to claim 1, wherein said dispensing unit is configured for receiving a label roll and processing a carrier strip with two label rows.

6. Thermo-forming packaging machine comprising:
a device for labeling a plurality of rows and/or lanes of packages, said device comprising:
a first depositor device;
a second depositor device; and
a dispensing unit that is common for said first and second depositor devices and is designed to simultaneously dispense a first row of labels onto said first depositor device and a second row of labels onto said second depositor device;
where said dispensing unit and said first and second depositor devices are combined to form a module such that they are jointly adjustable in their position by a common drive.

7. Thermo-forming packaging machine according to claim 6, wherein a direction of movement of said common drive is provided in and against a direction of processing of said thermo-forming packaging machine.

8. Thermo-forming packaging machine according to claim 6, wherein a direction of movement of said common drive is provided transverse to a direction of processing of said thermo-forming packaging machine.

9. Method for labeling packages in a thermo-forming packaging machine using a device comprising a dispensing unit, a first depositor device and a second depositor device, said method comprising the steps of:
simultaneously dispensing two label rows being parallel to each other from said dispensing unit onto each one of said depositor devices;
applying a first row of labels from said first depositor device onto a first row of packages;
applying a second row of labels from said second depositor device onto a second row of packages;
jointly moving said dispensing unit and said depositor devices to a different position;
repeatedly dispensing two label rows being parallel to each other from said dispensing unit onto said depositor devices;
applying a third row of labels from said first depositor device onto a third row of packages; and
applying a fourth row of labels from said second depositor device onto a fourth row of packages.

10. Method according to claim 9, wherein said application of said labels using said first depositing device and said second depositing device is performed simultaneously.

11. Method according to claim 9, wherein between application of said labels on said first and said third row of packages, respectively, and application of said labels on said second and said fourth row of packages, respectively, said dispensing unit and said two depositor devices are jointly moved to a position provided for said second and said fourth row, respectively.

12. Method according to claim 9, wherein said labels are transferred from a two-lane label roll from said dispensing unit onto said first depositor device and said second depositor device.
